(19) United States
(12) Patent Application Publication
(10) Pub. No.: US 2007/0026372 A1
(43) Pub. Date: Feb. 1, 2007

(54) Method for providing machine access security by deciding whether an anonymous responder is a human or a machine using a human interactive proof

(76) Inventor: Lorenz Francis Huelsbergen, Lebanon, NJ (US)

Correspondence Address: Lucent Technologies Inc.;Docket Administrator - Room 3J-219, 101 Crawfords Corner Road, Holmdel, NJ, 07733-3030, US

(21) Appl. No.: 11/190,714

(22) Filed: Jul. 27, 2005

(51) Int. Cl. G09B 3/00; G09B 7/00

(52) U.S. Cl. 434/322

(57) ABSTRACT

A method performed by a host computer for determining whether a client user is a human or a machine. In an interactive process, the host poses a sequence of questions about an object to the client, receives answers back therefrom, and compares the received answers to the correct answers to determine whether the user is a human or a machine. Illustratively, the series of questions may, for example, comprise a version of the well-known “game” of twenty questions in which all questions are yes/no questions. The object is selected from a database comprising a plurality of objects and associated questions (with corresponding correct answers) relating thereto, and an image of the object is presented to the client user. The host computer then determines that the client user is, in fact, a human if, for example, all questions about the selected object are answered correctly.

### FIELD OF THE INVENTION

The present invention relates generally to the field of machine access security techniques and in particular to a method for distinguishing between human and automated responses for machine access with use of a human interactive proof or reverse Turing test.

### BACKGROUND OF THE INVENTION

It is often necessary or advisable that an automated system which offers user access to a given resource be able to ensure that the user requesting such access is, in fact, a human being and not itself an automated (i.e., computer) system. For example, web sites that offer free e-mail accounts, or web services that offer items for sale or auction, may want to ensure that the user accessing the site is human and not a machine. In addition, certain e-mail spam filtering systems, or alternatively, e-mail virus protection systems, may want to ensure that the sender of a given e-mail is a human and not a machine.

One technique by which automated systems can achieve such a goal of determining whether a user attempting to access the system is a human or a machine is with use of what is known as a “human interactive proof” (HIP) or a “reverse Turing test.” A human interactive proof presents a user (or the user's computer) with a puzzle that is hard or expensive in time (and therefore in cost) for a machine to solve. A reverse Turing test is a challenge posed by a computer which only a human should be able to solve.

In a seminal work, fully familiar to those skilled in the computer arts, the well known mathematician Alan Turing proposed a simple “test” for deciding whether a machine possesses intelligence. Such a test is administered by a human who sits at a terminal in one room, through which it is possible to communicate with another human in second room and a computer in a third. If the giver of the test cannot reliably distinguish between the two, the machine is said to have passed the “Turing test” and, by hypothesis, is declared “intelligent.”

Unlike a traditional Turing test, however, a reverse Turing test is typically administered by a computer, not a human. The goal is to develop algorithms able to distinguish humans from machines with high reliability. For a reverse Turing test to be effective, nearly all human users should be able to pass it with ease, but even the most state-of-the-art machines should find it very difficult, if not impossible. (Of course, such an assessment is always relative to a given time frame, since the capabilities of computers are constantly increasing. Ideally, the test should remain difficult for a machine for a reasonable period of time despite concerted efforts to defeat it.)

Specifically, such reverse Turing tests have come to be known as CAPTCHAs (completely automated public Turing test to tell computers and humans apart). Most typically, these systems work by presenting the user with an image containing some text (e.g., an English language word containing a sequence of alphabetic characters) which has been distorted in some way to make it difficult for computer text recognition software to identify the characters, but relatively easy for a human to identify. These ideas have been extended to the task of identifying auditory and other visual information as well.

Prior art CAPTCHAs and HIPs often have the limitation that the challenge posed is either too easy to break (i.e., solve) by, for example, a machine guessing the correct answer a significant percentage of the time, or too difficult for humans. Therefore, an improved CAPTCHA which is neither too easy for a computer to solve nor too hard for humans would be highly desirable.

### SUMMARY OF THE INVENTION

In accordance with the principles of the present invention, a novel instance of an HIP that advantageously incorporates certain features of CAPTCHAs is provided, whereby an interactive process involving a short series (i.e., a plurality) of, for example, yes/no or multiple choice questions about a media object (e.g., an image) is asked and answered to determine whether a given user is a human or a machine. Illustratively, the series of questions may, for example, comprise a version of the well-known “game” of twenty questions in which all questions are yes/no questions. The novel technique of the present invention solves the problems of prior art CAPTCHAs and HIPs since it is highly unlikely that computer-generated guesses for all of the questions asked will be correct, and yet it is easy for a human to answer the questions correctly (as evidenced by the fact that even children can play the game of twenty questions successfully).

Specifically, the present invention provides a method performed by a host computer for determining whether a client user is a human, the method comprising the steps of selecting an object from a database comprising a plurality of objects, the database further comprising, for each of said objects comprised therein, an identity of said object, a plurality of questions concerning said object associated therewith, and a corresponding plurality of correct answers to said questions concerning said object; providing an instantiation of the selected object to the client user; posing to the client user a sequence of two or more of said plurality of questions associated with said selected object in said database and receiving, in turn, corresponding answers thereto; comparing said received answers corresponding to said posed questions in said sequence of questions with said corresponding correct answers to said questions; and identifying said client user as a human based on said comparison of said received answers to said posed questions to said corresponding correct answers to said questions.

### BRIEF DESCRIPTION OF THE DRAWINGS

FIG. 1 shows a flowchart of a method for determining whether a given client user is a human or a machine in accordance with one illustrative embodiment of the present invention.

FIG. 2 shows a flowchart of a method, in accordance with one illustrative embodiment of the present invention, for adding an object to a database for use by the illustrative method for determining whether a given client user is a human or a machine shown in FIG. 1.

### DETAILED DESCRIPTION OF THE ILLUSTRATIVE EMBODIMENTS

In the well known children's game of twenty questions, one person secretly thinks of an object (which may be initially described to the other person as being an animal, vegetable or mineral), and the other person is required to interactively ask a series of (up to twenty) yes/no questions whose purpose is to help him or her identify the secret object. In accordance with an illustrative embodiment of the present invention, a host computer, which wishes to ascertain if a client—either local or remote—is being operated by a human or a machine, provides the client with an object and then poses a series of questions to the client about that object. In accordance with one illustrative embodiment of the present invention, the object is provided as an image (i.e., a picture of the object), although in accordance with other illustrative embodiments of the invention, the object may be provided in other media forms such as, for example, sound (i.e., audio) or video clips.

Advantageously, the host, in accordance with an illustrative embodiment of the present invention, maintains a database of (preferably, a large number of) images of various objects which may, for example, include images of things, animals, people, etc. (or, alternatively, of sounds, videos, etc.). Associated with each of these objects and stored in the database therewith is a plurality of questions about the object, each such question having a clearly correct answer associated which is also stored therewith. For example, the questions may comprise yes/no questions, each with a well-defined yes/no correct answer.

To ascertain whether the client is a human or a machine, the host, in accordance with an illustrative embodiment of the present invention, presents an image of a selected one of these objects to the client, and then proceeds to pose to the client a series of questions (selected from the set of questions associated with the selected object) about it. The object may, for example, be advantageously selected randomly from the objects stored in the database. In addition, the questions may, for example, be selected such that the questions' subjects proceed from general to more specific. In response to the host's posing of the questions, the client answers each question in turn, and the host, in accordance with an illustrative embodiment of the present invention, determines whether the answer given by the client agrees with the answer stored in the database and associated with the given question for the given object—in other words, the host determines whether the given answer is “correct.”

In accordance with an illustrative embodiment of the present invention, in order for a given client to “pass” the “test”—that is, in order for the host to identify the client as a human rather than as a machine, the client should advantageously answer all questions posed correctly. (In accordance with other illustrative embodiments of the present invention, the host may identify the client as a human rather than as a machine based on, for example, a predetermined number or percentage of the answers being correct, although such a relaxation of the expectation that a human client will answer all questions correctly may increase the risk of misidentifying a machine as a human.) Note that, in accordance with this illustrative embodiment, if, for example, a total of k yes/no questions are asked about a given object, the odds that a machine posing as a human will correctly guess the answers to all k questions is 2^{-k} (assuming a uniform distribution of answers to the set of yes/no questions), which, even for small values of k (like, for example, 10), is very unlikely.

By way of example, assume that the client is shown by the host an easily recognizable picture (i.e., an image) of a dog. The host might then proceed to ask the following sequence of questions, in turn:

Is it a vegetable?

Is it an animal?

Does it live in water?

Is it a mammal?

Does it have four or more legs?

Does it have fur?

Does it eat meat?

Does it only live outdoors?

Does it only live indoors?

Is it kept as a pet?

etc.

Note that answering all of these questions in response to a clearly recognizable picture of a dog does not take long. In fact, it may even be a fun task for a human to play this game at the client while authorizing himself or herself as being human. Advantageously, note that the host should not query esoteric information about the object, to ensure that a human client would know the correct answers.

In accordance with an illustrative embodiment of the present invention, the host may advantageously randomize the order of the questions asked for a given object, or may randomly select a subset of the questions stored in association with a given object. In this manner, it will be extremely difficult for a machine posing as a human to guess the right sequence of correct answers, even if the machine somehow knows which object has been selected by the host and which questions have been associated therewith (for example, by monitoring many or all past challenges by the host).

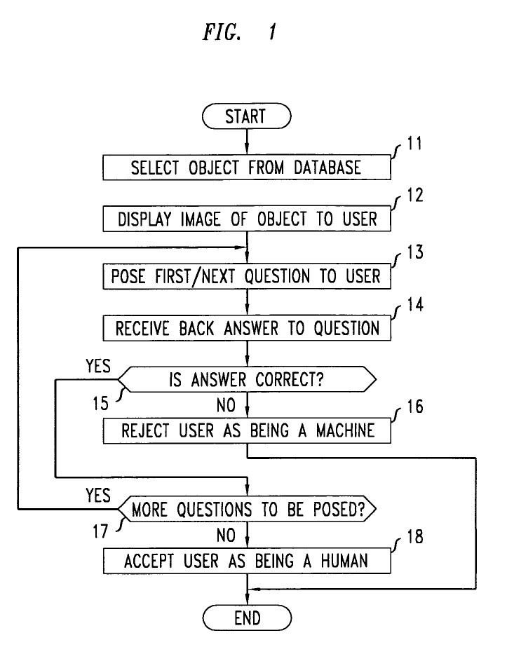

FIG. 1 shows a flowchart of a method for determining whether a given client user is a human or a machine in accordance with one illustrative embodiment of the present invention. In particular, as shown in block 11 of the figure, an object is randomly selected from the database and an associated sequence of questions and their corresponding correct answers is identified (in the database). Then, as shown in block 12 of the figure, an image of the object is extracted from the database and is displayed to the client user. Next, as shown in block 13 of the figure, a (first) question about the object is selected from the associated sequence of questions and is posed to the client user. Then, as shown in block 14, a response to the question posed in block 13 is received.

Decision block 15 then compares the answer received in block 14 with the correct answer (which is retrieved from the database). If the received answer does not agree with the correct answer, the client user is “rejected” as being a machine and the procedure terminates, as shown in block 16 of the figure. If, on the other hand, the received answer agrees with the correct answer, decision block 17 determines whether all of the questions from the associated sequence of questions have been posed to the client user. If all of the questions from the associated sequence of questions have been posed to the client user, the client user is “accepted” as being a human, as shown in block 18 of the figure, and the procedure terminates. If there are questions from the associated sequence of questions that have not yet been posed to the client user, flow control returns to block 13, where the next question about the object is selected from the associated sequence of questions and is posed to the client user.

As pointed out above, the host, in accordance with the above-described illustrative embodiment of the present invention advantageously selects an object from a database for use in determining whether a given client is a human or a machine. In accordance with an illustrative embodiment of the present invention, such a database may be generated and maintained using one or more of the following techniques.

First, in accordance with an illustrative embodiment of the present invention, the questions associated with each object advantageously comprise a number of general questions about the object which are shared with other objects in the database, as well as one or more specific questions which may be associated with only the given object. Next, also in accordance with the illustrative embodiment of the present invention, the database advantageously comprises a question tree in which each leaf of the tree is representative of one of the objects in the database. (Trees are well-known data structures fully familiar to those of ordinary skill in the art, and, therefore, the structure of such a question tree will be obvious to those skilled in the art.)

Given the use of such a question tree in accordance with one such illustrative embodiment of the present invention, the host, which may, for example, serve as the CAPTCHA administrator, might advantageously add a new object to the database by simply walking through the existing question tree and answering questions until it reaches a leaf of the tree representing an existing object, and by then adding one or more new questions to the tree that advantageously distinguishes the existing object from the new object being added. Note that adding multiple questions to distinguish the existing object from the object being added advantageously allows the illustrative host, during operation (of the process of determining whether a given client is a human or a machine), to randomly choose one (or more) of the multiple disambiguating questions to thereby make it even harder for a machine to guess the answers based on a knowledge of past challenges. (See discussion on machine guessing above.)

In accordance with an illustrative embodiment of the present invention, the above-described question tree is maintained by the CAPTCHA administrator as a “balanced” tree. (As is fully familiar to those of ordinary skill in the art, a balanced tree has essentially the same shape if possible in all of its immediate descendant subtrees. For example, a balanced binary tree will have the same shape for its left and right subtrees to the extent feasible.) Advantageously, the use of a balanced question tree will ensure that all of the possible answers to the questions describe a valid concept in the database and that there is, therefore, no possible bias that can be exploited by repeatedly guessing any particular series of answers. In accordance with this illustrative embodiment of the present invention, a computer program may be used to examine the database and indicate to the CAPTCHA administrator where an object should be added to maintain balance in the database. Algorithms to implement such functionality are well-known and will be obvious to those skilled in the art.

Note that the use of an approach to adding entries to the database such as those described above advantageously allows for the addition of tens or hundreds of objects a day to the database, thereby making the use of a database comprising thousands of objects quite practical. Possible sources for abundant images of various objects for addition into such a database include web search engines, which often provide a capability to search for images matching a search query. For example, if the database administrator wished to add a “dog” object to the database, a search engine image query for “dog” will retrieve many suitable example images of dogs. Thus, in accordance with one illustrative embodiment of the present invention, such web search engines may be advantageously employed to build a database comprising images of a large number of objects along with questions (and answers) to be associated therewith.

And, in accordance with one illustrative embodiment of the present invention, the CAPTCHA administrator may suggest one or more positions in the tree which might be advantageously filled in with a new object to be added, in order to help maintain the tree as a balanced tree. In the case of a binary tree, for example, this will advantageously make it harder for a machine client to guess the correct answers, since there will be less bias between “yes” and “no” answers.

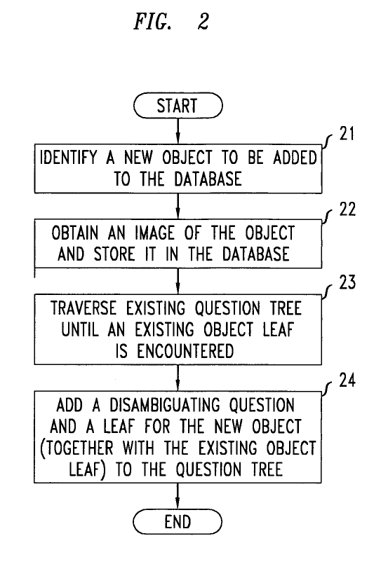

FIG. 2 shows a flowchart of a method, in accordance with one illustrative embodiment of the present invention, for adding an object to a database for use by the illustrative method for determining whether a given client is a human or a machine shown in FIG. 1. In particular, as shown in block 21 of the figure, a new object to be added to the database is identified, and, as shown in block 22 of the figure, an image of that object is obtained (e.g., with use of a Internet search engine) and stored in the database. Then, as shown in block 23 of the figure, the existing question tree is traversed (based on the object being added) until a leaf of the tree (representing an object already present in the database) is encountered. Finally, as shown in block 24 of the figure, a new question which distinguishes the existing object from the new object is added to the tree (at the location of the existing leaf), such that both the new object and the previously existing object become (alternative) leaves of the tree immediately after the added question.

### ADDENDUM TO THE DETAILED DESCRIPTION

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

I claim:

1. An automated method performed by a host computer for determining whether a client user is a human, the method comprising the steps of:
selecting an object from a database comprising a plurality of objects, the database further comprising, for each of said objects comprised therein, an identity of said object, a plurality of questions concerning said object associated therewith, and a corresponding plurality of correct answers to said questions concerning said object;
providing an instantiation of the selected object to the client user;
posing to the client user a sequence of two or more of said plurality of questions associated with said selected object in said database and receiving, in turn, corresponding answers thereto;
comparing said received answers corresponding to said posed questions in said sequence of questions with said corresponding correct answers to said questions; and
identifying said client user as a human based on said comparison of said received answers to said posed questions to said corresponding correct answers to said questions.

2. The method of claim 1 wherein said instantiation of the selected object comprises an image of said selected object.

3. The method of claim 1 wherein said step of identifying said client user as a human comprises identifying said client user as a human if each of said received answers corresponding to said posed questions in said sequence of questions agrees with said corresponding correct answers to said questions.

4. The method of claim 1 wherein one or more of said questions in said sequence of questions posed to the client user are selected at least in part randomly from said plurality of questions associated with said selected object in said database.

5. The method of claim 1 wherein one or more of said questions in said sequence of questions posed to the client user are selected from said plurality of questions associated with said selected object in said database based on one or more previous questions in said sequence.

6. The method of claim 1 wherein each of said questions in said sequence of questions posed to the client user comprises a binary question having either a “yes” or “no” answer.

7. The method of claim 1 wherein said sequence of questions posed to the client user comprises one or more general questions concerning the object followed by one or more specific questions concerning the object.

8. The method of claim 1 wherein said database comprises a question tree comprising said plurality of questions concerning each of said objects comprised in said database, and wherein each of said objects comprised in said database is represented as a leaf in said question tree.

9. The method of claim 8 wherein said question tree comprises a balanced tree.

10. The method of claim 8 wherein said plurality of questions concerning each of said objects comprised in said database comprises a binary question having either a “yes” or “no” answer and wherein said question tree comprises a binary tree.

11. A host computer system adapted to perform an automated method for determining whether a client user is a human, the host computer comprising a processor wherein the processor has been adapted to:
select an object from a database comprising a plurality of objects, the database further comprising, for each of said objects comprised therein, an identity of said object, a plurality of questions concerning said object associated therewith, and a corresponding plurality of correct answers to said questions concerning said object;
provide an instantiation of the selected object to the client user;
pose to the client user a sequence of two or more of said plurality of questions associated with said selected object in said database and receive, in turn, corresponding answers thereto;
compare said received answers corresponding to said posed questions in said sequence of questions with said corresponding correct answers to said questions; and
identify said client user as a human based on said comparison of said received answers to said posed questions to said corresponding correct answers to said questions.

12. The host computer system of claim 11 wherein said instantiation of the selected object comprises an image of said selected object.

13. The host computer system of claim 11 wherein said client user is identified as a human if each of said received answers corresponding to said posed questions in said sequence of questions agrees with said corresponding correct answers to said questions.

14. The host computer system of claim 11 wherein one or more of said questions in said sequence of questions posed to the client user are selected at least in part randomly from said plurality of questions associated with said selected object in said database.

15. The host computer system of claim 11 wherein one or more of said questions in said sequence of questions posed to the client user are selected from said plurality of questions associated with said selected object in said database based on one or more previous questions in said sequence.

16. The host computer system of claim 11 wherein each of said questions in said sequence of questions posed to the client user comprises a binary question having either a “yes” or “no” answer.

17. The host computer system of claim 11 wherein said sequence of questions posed to the client user comprises one or more general questions concerning the object followed by one or more specific questions concerning the object.

18. The host computer system of claim 11 wherein said database comprises a question tree comprising said plurality of questions concerning each of said objects comprised in said database, and wherein each of said objects comprised in said database is represented as a leaf in said question tree.

19. The host computer system of claim 18 wherein said question tree comprises a balanced tree.

20. The host computer system of claim 18 wherein said plurality of questions concerning each of said objects comprised in said database comprises a binary question having either a “yes” or “no” answer and wherein said question tree comprises a binary tree.
